(19) United States
(12) Patent Application Publication
(10) Pub. No.: US 2025/0140948 A1
(43) Pub. Date: May 1, 2025

(54) Battery Pack, System having a Battery Pack and an Electrical Consumer and/or a Charging Device, and Method of Operating a Battery Pack

(71) Applicant: Robert Bosch GmbH, Stuttgart (DE)

(72) Inventor: Holger Wernerus, Pliezhausen (DE)

(21) Appl. No.: 18/924,779

(22) Filed: Oct. 23, 2024

(30) Foreign Application Priority Data
Oct. 25, 2023 (DE) 10 2023 210 523.3

(51) Int. Cl. H01M 10/42; B25F 5/00; H01M 10/46; H02J 7/00

(52) U.S. Cl. CPC H01M 10/425; H01M 10/46; H02J 7/00032; H02J 7/0031; B25F 5/00; H01M 2010/4278; H01M 2220/30; H02J 7/0068

(57) ABSTRACT

A battery pack includes (i) at least one connection interface for connection to an electrical consumer, in particular an electric hand tool, and/or to a charging device, and (ii) a signal output unit configured so as to output at least one analog signal and at least one digital signal via at least one shared signal contact of the connection interface. The signal output unit includes at least one electric circuit configured so as to switch between a digital operating mode of the signal output unit and an analog operating mode of the signal output unit.

This application claims priority under 35 U.S.C. § 119 to patent application no. DE 10 2023 210 523.3, filed on Oct. 25, 2023 in Germany, the disclosure of which is incorporated herein by reference in its entirety.

### BACKGROUND

A battery pack having a signal output unit, which is provided for analog data exchange via a signal contact, has already been proposed.

### SUMMARY

The disclosure relates to a battery pack having at least one connection interface for connection to an electrical consumer, in particular an electric hand tool, and/or to a charging device having a signal output unit configured so as to output at least one analog signal and at least one digital signal via at least one shared signal contact of the connection interface.

It is proposed that the signal output unit comprises at least one electric circuit configured so as to switch between a digital operating mode of the signal output unit and an analog operating mode of the signal output unit.

With the inventive design of the battery pack, a fast data transmission on a sensitive interface can advantageously be enabled, which is advantageously robust compared to electrostatic discharges and/or has a high electromagnetic compatibility. Advantageously, as safe and efficient as possible an operation of an energy store device of the battery pack can be provided. A battery pack which is provided for both digital data exchange and analog data exchange, in particular via a connection interface, can also be advantageously provided. Furthermore, an analog and/or digital interface can advantageously be provided with the signal contact, which is configured so to be advantageously backwards-compatible, in particular with analog electrical consumers, preferably with an analog interface, particularly preferably old electrical consumers, and/or forwards-compatible, in particular with digital electrical consumers, preferably with a digital interface, particularly preferred with newly developed electrical consumers. Here, it can be advantageously ensured by adding a digital switching unit that old battery packs are still compatible with new electrical consumers and/or charging devices and old electrical consumers and/or charging devices with new battery packs.

In particular, the battery pack comprises at least one energy store. The battery pack, in particular the energy store, comprises at least one battery cell, preferably a plurality of battery cells, for storing electrical energy. The battery pack, in particular the energy store, is not limited to a particular type of battery cell, but rather battery cells of the battery pack can be configured as lithium ion cells, for example, and/or as lithium polymer cells and/or as nickel cadmium cells and/or the like. Likewise, the battery cells of the battery pack according to the disclosure are not limited to a specific geometry and/or a specific format, but rather can have different cell geometries and/or cell formats and can be configured, for example, as a round cell or flat cell or pouch cell or the like, without leaving the scope of the present disclosure.

In particular, the battery pack is provided for connection to at least the electrical consumer, in particular to the preferably wireless electric hand tool, along the connection direction and in a connected state to a power supply of at least one unit, for example a drive unit and/or a display unit, of the electrical consumer, in particular the electric hand tool. The battery pack is not limited to use with a particular type of electric hand tools, but can be generally provided for connection to different types of electric hand tools. An electric hand tool, to which the battery pack can be connected, can be configured, for example, without limiting hereto, as a cordless screwdriver and/or as a drilling machine and/or as a grinding machine and/or as an electric saw, e.g. a reciprocating saw and/or as a mill and/or as a hot glue gun and/or as a fan and/or as a multi-function tool and/or as a polishing machine and/or as a planing machine and/or as a comparable hand tool machine. It is also conceivable that the battery pack is provided for alternating use with various electric hand tools.

Preferably, the battery pack is provided for connection to at least the charging device, along the connection direction and in a connected state to a charge of the battery pack by an external power source. Preferably, the charging device has an input port connected to the external power source and an output port connected to the battery pack. In particular, the charging device comprises a control/regulation unit that controls and/or regulates the charging operations, in particular on the basis of a state of charge, a rated voltage, and/or a capacity of the battery pack, and sets a suitable charging method.

Preferably, the connection interface serves as an electromechanical interface between the electrical consumer and/or the charging device. Preferably, the connection interface comprises at least two power contacts configured for an electrical connection to the charging device and/or the electrical consumer, in particular with a connection interface of the electrical consumer and/or the charging device, in particular for discharging and/or charging. Preferably, the connection interface of the battery pack consists of contact tulips which are inserted into one another as contact blades for connection with the connection interface of the electrical consumer and/or charging device.

Preferably, the connection interface comprises at least the signal contact, which is in particular separate from the power contacts of the connection interface. Preferably, the signal contact is provided for a signal transmission, in particular of the analog and digital signal, from the battery pack to the electrical consumer and/or charging device, preferably for a corresponding signal contact of the electrical consumer and/or charging device. Particularly preferably, the connection interface of the electrical consumer and/or the charging device comprises at least the signal contact corresponding to the signal contact.

Preferably, the signal output unit at least partially forms the signal contact or is at least partially built onto the signal contact. In particular, the digital signal is modulated on an analog line. Preferably, the signal output unit comprises at least one signal output element, in particular a digital signal output element, which is provided for receiving and/or transmitting the digital signal, and an analog signal output element, which is provided for transmitting and/or receiving, in particular a reading out, of the analog signal. Preferably, the electrical consumer and/or the charging device comprise at least one further signal output unit provided for receiving and/or transmitting the analog and/or digital reception.

Preferably, the analog signal output element comprises at least one coding resistor, in particular for battery coding, and/or at least one NTC resistor, in particular as a temperature sensor for measuring a temperature of the battery pack, which is readable via the signal contact, in particular from the signal output unit of the electrical consumer and/or the charging device, preferably using the control/regulation unit of the electrical consumer and/or the charging device. Preferably, the analog signal is a signal given by reading out the resistance. In particular, the analog signal is used in order to read out a power capability, a voltage, a configuration and/or a temperature of the battery pack, in particular the battery cell. In particular, the analog signal output element has at least one resistance between 1 kOhm and 1 MOhm as the coding resistor, in particular adapted to the values of the battery cell. In particular, the analog signal output element, as an NTC resistor, in particular adapted to the values of the battery cell, preferably due to temperature, in particular has a resistance of between 1 MOhm and 10 Ohm, preferably between 100 kOhm and 100 Ohm, and particularly preferably between 50 kOhm and 1 kOhm.

Preferably, the battery pack comprises at least one control/regulation unit, which is connected to the signal output unit, in particular electrically, at least for sending and/or receiving purposes. Preferably, the control/regulation unit is provided for communication with the control/regulation unit of the electrical consumer and/or charging device. In particular, the control/regulation unit at least partially forms the digital signal output element.

In particular, the digital signal output element is configured at least in part as a digital bus system for transmitting and/or receiving the digital signal. Various protocols and driver circuits are known for such digital bus systems, including but not limited to UART and LIN. Preferably, the digital signal output element, in particular the digital bus system, operates according to a master/slave principle. In particular, the digital signal output element comprises a transmission element, in particular a bus line, for transmitting the digital signal. Preferably, for receiving and/or transmitting the digital signal, the digital signal output element comprises a receiver circuit, in particular a receiver, and a pull-down circuit. Particularly preferably, the bus line is directly connected to the signal contact, wherein the analog signal and the digital signal are each transmissible via the bus line. Preferably, as a digital signal output element, the electrical consumer and/or charging device comprises the complimentary digital bus system having at least one further transmission element, in particular a bus line, a receiver circuit, and a pull-down circuit.

Preferably, the signal output unit, in particular circuit components for transmission, preferably outputting, of the digital signal, preferably at least the digital signal output element, particularly preferably at least the digital bus system of the signal output unit, is connected to the signal contact, in particular built on or added to the signal contact. In at least one embodiment of the battery pack according to the disclosure, the signal output unit at least partially, preferably the digital signal output element, preferably the digital bus system, is configured so as to be separable from the signal contact, in particular the battery pack. It can thus be advantageously achieved that a battery pack, which only comprises a signal output unit for analog signal transmission, is supplemented with the digital signal output element, particularly preferably the digital bus system. Preferably, the digital signal is a charging status, a cell voltage, a temperature measurement and/or a temperature warning, an error message, an authentication signal, a remaining run-time, or another signal that appears reasonable to a person skilled in the art. Advantageously, the digital signal serves to enhance interaction between the electrical consumer, in particular the electrical hand tool, and the user, provides safety features, and helps extend the life of the battery pack. In particular, the digital bus system is provided at a data rate of at least 1 kBaud, preferably at least 10 kBaud, advantageously at least 50 kBaud, and particularly preferably at least 100 kBaud. In particular, slower data rates can also be useful for specific applications.

Preferably, the electric circuit is configured so as to switch between the analog operating mode and the digital operating mode to at least one electric circuit component in such a way that the signal output unit outputs only the analog signal or the digital signal, in particular via at least the same signal contact of the connection interface. Preferably, the signal output unit in the analog operating mode is configured so as to output the analog signal. Particularly preferably, in the analog operating mode, the electric circuit is configured so as to provide a reading-out of the analog signal output element, in particular the coding resistor or the NTC resistor. Preferably, in the digital operating mode, the signal output unit is configured so as to output the digital signal. Particularly preferably, in the digital operating mode, the electric circuit is configured so as to provide the transmission and/or reception of the digital signal, preferably during a communication of the control/regulation unit of the battery pack with the control/regulation unit of the electrical consumer and/or charging device. In particular, the electric circuit at least partially forms the digital bus system.

Furthermore, it is proposed that, in the digital operating mode, the electric circuit is configured so as to electrically disconnect the analog signal output element of the signal output unit from the signal contact of the signal output unit. As a result, a signal level necessary for bus communication can advantageously be achieved as easily as possible in a stable manner, despite a range of resistances given by the analog signal output element. Preferably, the electric circuit detects when digital communication is to be present, so that the electric circuit electrically disconnects the analog signal output element from the signal contact. Particularly preferably, in the digital operating mode of the signal output unit, the digital signal output element, in particular the digital bus system, is unaffected by the analog signal output element. Preferably, the digital signal output element, in particular the digital bus system, comprises an ESD protection circuit, which is preferably configured, in particular in the digital operating mode, preferably together with the analog signal output element, to reduce existing capacity to a maximum of 100 nF, preferably to a maximum of 10 nF, advantageously to a maximum of 5 nF, and particularly preferably to a maximum of 1 nF. As a result, the switching edges of the bus line can advantageously be transmitted immediately. Preferably, the ESD protection circuit comprises at least one ESD suppressor diode.

Furthermore, it is proposed that the electric circuit is configured so as to electrically disconnect the digital signal output element of the signal output unit from the signal contact in an analog operating mode of the signal output unit. As a result, advantageously, the output of the analog signal, in particular a reading-out of the analog signal output element, preferably when implementing the digital signal output element on the same signal contact, can be provided. Preferably, it is detected with the electric circuit when a digital signal output is ended, so that the electric circuit electrically disconnects the digital signal output element from the signal contact. Particularly preferably, in the analog operating mode of the signal output unit, the analog signal output element is unaffected by the digital signal output element. Preferably, the switching element is configured so as to prevent a current flowing parallel to analog signal output element in the analog operating mode. Particularly preferably, the electrical signal output unit, and in particular the digital signal output element, is electrically disconnected from the signal contact outside of a digital signal transmission in the analog operating state.

In addition, it is proposed that the electric circuit comprises at least a first switching element for electrically disconnecting the digital signal output element and at least one further switching element for electrically disconnecting the analog signal output element. As a result, advantageously, the switching between the digital operating mode and the electrical operating mode can be provided, with inexpensive and widely available components. Preferably, the first switching element for electrically disconnecting the digital signal output element and the at least one further switching element for disconnecting the analog signal output element are configured separately from one another. Preferably, the first switching element is configured so as to prevent the current flowing parallel to the analog signal output element in the analog operating mode. Particularly preferably, the first switching element is a semiconductor switch, such as an NPN BJT and/or n-type MOSFET. Particularly preferably, the first switching element is arranged in the digital signal output element, in particular in the digital bus system, preferably in an input circuit of the receiver circuit of the digital signal output element. Preferably, the input circuit is part of the electric circuit. In particular, the at least one further switching element is arranged directly on the analog signal output element. Preferably, the further switching element is configured as a semiconductor switch, in particular as a MOSFET semiconductor switch. Preferably, when using an NTC resistor as an analog signal output element, the MOSFET semiconductor switch already established with an NTC resistor is configured as the switching element.

Furthermore, it is proposed that, in the analog operating mode of signal output unit, the in particular first switching element is configured so as to electrically disconnect leakage paths of the digital signal output element with a ground of battery pack. As a result, an interference-free analog operating mode, in particular an interference-free reading-out of the analog signal output element, can advantageously be provided. Preferably, in the analog mode of operation, the in particular first switching element is configured so as to prevent the current flowing parallel to analog signal output element with the leakage paths after a ground. In particular, the switching element is provided in order to prevent a current flow through the digital bus system. Preferably, in the analog operating mode, a current flow is provided through the analog signal output element.

It is further proposed that the signal output unit comprises at least one activation unit, which is configured so as to switch from the analog operating mode to the digital operating mode in case of a detection and/or recognition of an in particular digital activation signal, in particular to switch the at least one first switching element and the at least one further switching element. As a result, an interference with the analog signal output element, in particular in the analog operating mode, can advantageously be avoided. Preferably, the in particular first switching element is configured so as to close the leakage paths of the digital signal output element to the ground, in particular starting from the activation signal. Particularly preferably, the activation unit for a pulse detection is provided. Particularly preferably, the activation signal is a pulse sequence, which preferably comprises signal flanks within a defined time period. Preferably, the activation signal is binary, wherein any defined binary coding is conceivable, such as “101 0101” for example. Preferably, the activation unit is configured so as to at least substantially prevent interference signals of the digital signal output element in the analog operating mode. Particularly preferably, the activation unit comprises at least one high pass filter, which is configured at least so as to permanently prohibit a current flow in the activation unit, in particular in the analog operating mode. Preferably, the activation unit comprises at least one transistor, in particular an NPN BJT transistor. Preferably, the high pass filter is provided so as to direct a signal, preferably the activation signal, in a filtered manner to the transistor. Preferably, the transistor is provided in order to transmit the signal, preferably the activation signal, to the control/regulation unit, which is preferably provided for a check of the signal, preferably of the activation signal. In particular, the control/regulation unit is provided in order to establish the digital operating mode as the activation signal when verifying the signal, wherein in particular the control/regulation unit closes the first switching element for electrically disconnecting the digital signal output element and opens the further switching element for electrically disconnecting the analog signal output element.

Particularly preferably, the activation unit comprises at least one diode, which is configured so as to decouple a capacitance of the high pass filter from the transmission element, in particular the bus line. This can advantageously reduce an interference with the bus line, in particular in the digital operating mode. In particular, the diode is configured as a Schottky diode, preferably due to a lower flux voltage. Preferably, the activation unit comprises a resistor, which is preferably connected in parallel to the high-pass capacitor. In particular, the resistor is provided in order to ensure a defined discharge of the capacitor.

In an alternative embodiment of the battery pack according to the disclosure, the activation unit comprises an activation switch on a battery pack housing and/or on the electrical consumer and/or charging device. In particular, the activation switch is manually actuatable. Preferably, the activation switch is provided in order to switch the signal output unit from the analog operating mode to the analog operating mode.

In addition, it is proposed that the battery pack comprises at least the energy store configured so as to provide at least one utility energy for an operation of the electrical consumer and a signal voltage of the signal output unit for the digital operating mode. Preferably, the voltage level of the signal voltage reaches sufficiently high values of preferably at least 5 V, particularly preferably up to the battery voltage itself. As a result, a large voltage stroke compared to the ground can advantageously be provided, which advantageously allows for steep signal flanks. Further advantageously, even with large series resistors, the steep signal edges can be provided upstream of the energy store. Preferably, the signal output unit comprises at least one additional series resistor upstream of the energy store, in particular towards the digital signal output element. Preferably, the digital signal output element, in particular the digital bus system, is switched to the energy store, preferably from the bus master via an additional series resistor. Particularly preferably, the series resistor is arranged in the corresponding signal output unit of the electrical consumer and/or charging device. Preferably, the series resistor has a resistor of in particular at least 100 Ohm, preferably at least 500 Ohm, advantageously 1 kOhm, and particularly preferably at least 2 kOhm. In particular, for an energy store with 5× lithium ion cells, for example, the signal voltage, in particular as a pull-up voltage, is between 15 V and 21 V.

It is further proposed that the signal output unit comprises at least one voltage regulation unit, which is configured so as to stabilize and/or regulate the signal voltage, in particular to down-regulate it to a constant value, which is smaller than an output voltage of the energy store. As a result, a stable voltage can advantageously be achieved in the entire battery voltage range. Furthermore, advantageously, the interference radiation can be improved due to a limitation of maximum voltage strokes. Furthermore, a receiver can be advantageously detected with a transmitter in the digital bus system at the defined voltage level in an optimized manner. Preferably, the voltage regulation unit comprises at least one diode, in particular a Zener diode, for example a Zener diode type 8 V. In particular, the voltage regulation unit comprises a series resistor, which preferably has a resistance between 50 Ohm and 10 kOhm, advantageously between 100 Ohm and 1 kOhm, and particularly preferably between 250 Ohm and 500 Ohm. A series resistor having 330 Ohm is particularly suitable. In particular, the voltage regulation unit down-regulates the output voltage by at least 10%, preferably by at least 25%, advantageously by at least 33%, and particularly preferably by at least 45%. Preferably, the signal voltage, particularly as a high level, is in particular at a constant value of between 30 V and 1 V, preferably between 20 V and 2 V, advantageously between 15 V and 5 V, and particularly preferably between 10 V and 6 V. In particular, for a Zener diode type 8 V, the signal voltage is at approximately 8 V. In particular, the receiver circuit is configured so as to translate the signal voltage into a variable that is processable by a control/regulation unit, in particular a logic 1, for example by a translation to 3.3 V. Preferably, the translation of the receiver circuit is provided with a semiconductor switch, for example, with an n-type MOSFET semiconductor switch and/or an NPN BJT semiconductor switch.

Furthermore, it is proposed that the signal output unit comprises at least one voltage splitter configured so as to compensate for a ground offset between the battery pack and the electrical consumer and/or the charging device, in particular between the ground of the battery pack and a ground of the electrical consumer and/or the charging device. As a result, a stable signal transmission, in particular an unambiguous low level, can be advantageously provided between the battery pack and the electrical consumer and/or the charging device, in particular between master and slave, despite a high ground offset, in particular a ground offset of up to 2 V. Particularly preferably, the voltage splitter is switched in the input circuit of the receiver circuit of the digital signal output element. Preferably, the voltage splitter is positioned upstream of the semiconductor switch for translation, in particular the n-type MOSFET semiconductor switch and/or the NPN BJT semiconductor switch. In particular, the voltage splitter comprises an additional series resistor and a leakage resistor. Preferably, the voltage splitter has a voltage splitter ratio of in particular between 5% and 50%, preferably between 8% and 30%, advantageously between 10% and 20%, and particularly preferably between 10% and 15%. Particularly preferably, the voltage splitter has a voltage splitter ratio of about 13%, wherein the series resistor comprises about 10 kOhm and the leakage resistor comprises about 1.5 kOhm.

The disclosure further relates to a system having the battery pack and an electrical consumer and/or having a charging device, each comprising at least the connection interface to the connection with the battery pack and at least the signal output unit configured so as to at least output the analog signal via the connection interface via the signal contact of the battery pack.

With the inventive design of the system, a fast data transmission on a sensitive interface can be enabled, which is advantageously robust compared to electrostatic discharges and/or has a high electromagnetic compatibility. Furthermore, a system having an electrical consumer and/or a charging device can advantageously be provided for both digital data exchange and analog data exchange, in particular via the one connection interface.

The disclosure further relates to a method for operating the battery pack, wherein, in at least one method step, there is a switch between the analog operating mode and the digital operating mode.

With the inventive method, a fast data transmission on a sensitive interface can advantageously be enabled, which is advantageously robust compared to electrostatic discharges and/or has a high electromagnetic compatibility. Advantageously, as safe and efficient as possible an operation of an energy store device of the battery pack can be provided.

Preferably, after detection of the activation signal with the activation unit, there is a switch from the analog operating mode to the digital operating mode. Preferably, when switching from the analog operating mode to the digital operating mode, at least the first switching element is closed for the electrical disconnection of the digital signal output element and in particular the at least one further switching element is opened for the electrical disconnection of the analog signal output element. Preferably, when switching from the digital operating mode to the analog operating mode, at least the first switching element is opened for the electrical disconnection of the digital signal output element and in particular the at least one further switching element is closed for the electrical disconnection of the analog signal output element.

The battery pack according to the disclosure, the system according to the disclosure, and/or the method according to the disclosure are not intended to be limited to the application and embodiment described above. In particular, the battery pack according to the disclosure, the system according to the disclosure, and/or the method according to the disclosure may have a number of individual elements, components, and units that differs from a number specified herein in order to fulfill a function described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. Two exemplary embodiments of the disclosure are shown in the drawings. The drawings, the description, and the claims contain numerous features in combination. A person skilled in the art will appropriately also consider the features individually and combine them into additional advantageous combinations.

The figures show:

FIG. 1 a system according to the disclosure having a battery pack and having an electrical consumer, in particular an electric hand tool,

FIG. 2 a conceptual representation of a signal output unit of the battery pack and a signal output unit of the electrical consumer,

FIG. 3 a wiring of an input circuit of a receiver circuit of the signal output unit of the battery pack,

FIG. 4 a wiring of an activation unit of the signal output unit of the battery pack,

FIG. 5 a method of operating the battery pack, and

FIG. 6 a conceptual representation of an alternative embodiment of a signal output unit of a battery pack according to the disclosure.

### DETAILED DESCRIPTION

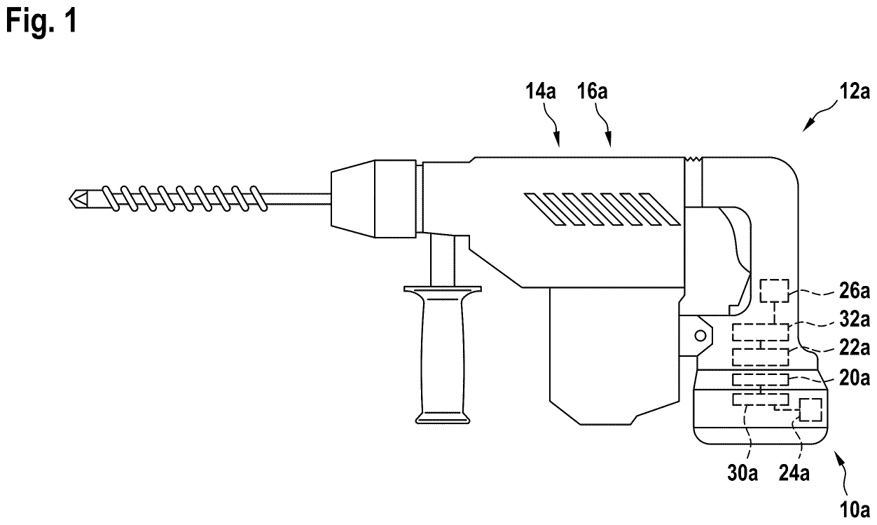

FIG. 1 schematically shows a system 12a having a battery pack 10a and having an electrical consumer 14a. The electrical consumer 14a is configured as an electric hand tool 16a, in particular as a battery-powered hammer. Alternatively, however, it is also conceivable that the consumer 14a is configured as a different consumer 14a that appears reasonable to a person skilled in the art. The battery pack 10a is arranged on the consumer 14a in a detachable manner, in particular in a damage-free detachable manner.

The battery pack 10a comprises an energy store 70a. The energy store 70a is configured at least so as to provide a utility power for operation of the electrical consumer 14a. The energy store 70a comprises a plurality of battery cells that are serially connected to one another. Alternatively, it is also conceivable that the energy store 70a has only one battery cell. The battery pack 10a is configured as a lithium ion battery pack 10a. Alternatively, it is also conceivable that the battery pack 10a is configured as a nickel cadmium battery pack 10a or as a different battery pack 10a that appears reasonable to a person skilled in the art. For example, the energy store 70a comprises five lithium ion cells. Thus, the energy store 70a provides a pull-up voltage between 15 V and 21 V.

The battery pack 10a comprises at least one control/regulation unit 24a. In particular, the control/regulation unit 24a comprises at least one processor and one memory element, as well as an operating program stored on the memory element. The memory element is configured as a digital storage medium, e.g. as a hard disk or the like. The control/regulation unit 24a comprises at least one protective function for protecting the battery cells. For example, the protective function is dependent on the at least one operating parameter. The operating parameter can be a voltage characteristic, a current characteristic, a resistance characteristic, a temperature characteristic, or the like. Preferably, the control/regulation unit 24a is disabled when the battery pack 10a is inactive. Particularly preferably, the control/regulation unit 24a is deactivated when the battery pack 10a is inactive, in particular in order to achieve as low a power consumption as possible.

The battery pack 10a comprises at least one connection interface 20a. The connection interface 20a is provided for connection to the electrical consumer 14a. The electrical consumer 14a comprises a further connection interface 22a. The further connection interface 22a of the electrical consumer 14a is provided for the connection to the battery pack 10a, in particular the connection interface 20a of the battery pack 10a.

The battery pack 10a is provided to supply electrical power to the electrical consumer 14a via the connection interface 20a. The connection interface 20a serves as an electromechanical interface between the electrical consumer 14a and/or the charging device. The connection interface 20a comprises at least two power contacts configured so as to provide an electrical connection to the electrical consumer 14a, in particular to two power contacts of the connection interface 22a of the electrical consumer 14a. The connection interface 20a of the battery pack 10a consists of contact tulips which are inserted into one another as contact blades for connection with the connection interface 22a of the electrical consumer 14a.

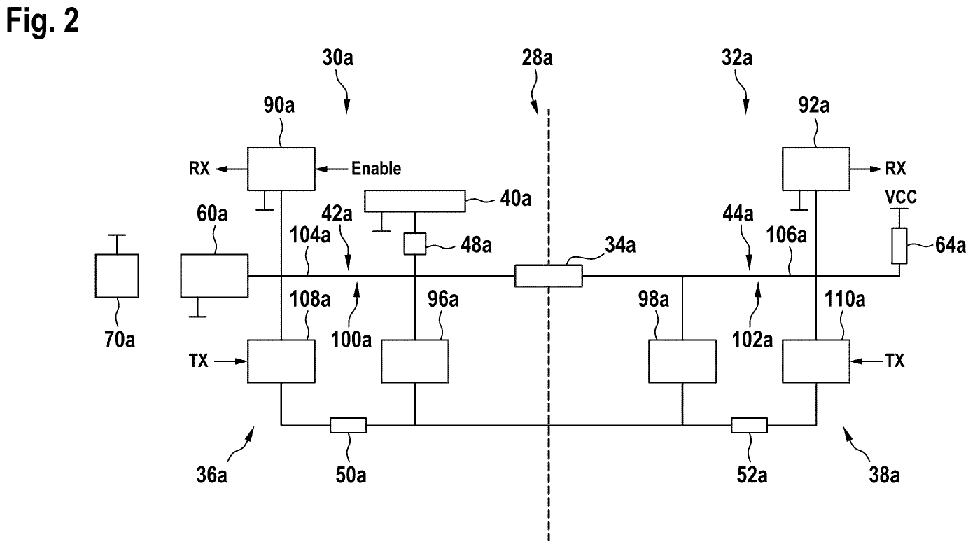

The connection interface 20a comprises at least one signal contact 34a (see FIG. 2). The signal contact 34a is provided for a signal transmission from the battery pack 10a to the electrical consumer 14a. The signal contact 34a is formed in the connection interface 20a, separate from the power contacts. The signal contact 34a is provided for transmission of an analog signal from the battery pack 10a to the electrical consumer 14a. The signal contact 34a is provided for transmission of a digital signal from the battery pack 10a to the electrical consumer 14a. The connection interface 22a of the electrical consumer 14a comprises a further signal contact 34a. The further signal contact 34a of the connection interface 22a of the electrical consumer 14a is provided for transmission of a digital signal from the electrical consumer 14a to the battery pack 10a. The signal contact 34a of the connection interface 20a of the battery pack 10a has electrical, in particular electromechanical, contact to the further signal contact 34a of the connection interface 22a of the electrical consumer 14a. The analog signal is transmitted from the signal contact 34a of the connection interface 20a of the battery pack 10a via the further signal contact 34a of the connection interface 22a of the electrical consumer 14a. The digital signal is transmitted from the signal contact 34a of the connection interface 20a of the battery pack 10a via the further signal contact 34a of the connection interface 22a of the electrical consumer 14a.

The battery pack 10a comprises at least one signal output unit 30a. The signal output unit 30a is configured so as to output at least one analog signal and at least one digital signal via at least the same signal contact 34a of the connection interface 20a (also see FIG. 2). The signal output unit 30a at least partially forms the signal contact 34a or is at least partially modulated onto the signal contact 34a. The electrical consumer 14a comprises a further signal output unit 32a. The signal output unit 32a of the electrical consumer 14a is configured so as to at least output the analog signal at least via the signal contact 34a of the battery pack 10a. The signal output unit 32a of the electrical consumer 14a is configured so as to at least output the digital signal via at least the same signal contact 34a of the battery pack 10a.

The control/regulation unit 24a is connected to the signal output unit 30a at least for transmitting and/or receiving the digital signal. The control/regulation unit 24a is provided for communication with a further control/regulation unit 26a of the electrical consumer 14a, in particular via the signal output unit 30a of the battery pack 10a and the further signal output unit 32a of the electrical consumer 14a.

The digital signal is a charging status, a cell voltage, a temperature measurement and/or a temperature warning, an error message, an authentication signal, a remaining run-time, or another signal that appears reasonable to a person skilled in the art. The digital signal serves to enhance interaction between the electrical consumer 14a, in particular the electrical hand tool 16a, and the user, provides safety features, and helps extend the life of the battery pack 10a.

The analog signal is given by at least one coding resistance, in particular for battery coding. Alternatively and/or additionally, the analog signal is given by at least one NTC resistance, in particular as a temperature sensor for measuring a temperature of the battery pack 10a, which is readable via the signal contact 34a, in particular by the signal output unit 32a of the electrical consumer 14a, preferably by way of the control/regulation unit 26a of the electrical consumer 14a. The analog signal is a signal given by reading out a coding resistance or NTC resistance. The analog signal is used in order to read out a power capability, a voltage, a configuration, and/or a temperature of the battery pack 10a, in particular of the battery cell (also see FIG. 2).

The battery pack 10a is provided for connection to at least one charging device. The charging device comprises at least one connection interface. The charging device comprises at least one signal transmission unit. The charging device has an input port connected to an external power source and an output port connected to battery pack 10a. Within the charging device, there is a control/regulation unit that monitors and controls the charging operations. In the further description of the exemplary embodiment, only the connection to the electrical consumer 14a will be described further. However, the description of the electrical consumer 14a is equally applicable to the charging device. The charging device at least approximately comprises the same components as the electrical consumer 14a. In any described feature of the electrical consumer 14a, the charging device can be implemented analogously. A difference could be made only in the power supply of the signal transmission unit, wherein it is contemplated for the charging device that the power supply is provided via an external current supply.

FIG. 2 conceptually shows the signal output unit 30a of the battery pack 10a and the signal output unit 32a of the electrical consumer 14a.

The signal output unit 30a comprises an analog signal output element 40a. The analog signal output element 40a is provided for outputting the analog signal. The analog signal is a signal given by reading out the analog signal output element 40a. The analog signal output element 40a is the coding resistance, in particular for battery coding, and/or at least the NTC resistance, in particular as a temperature sensor for measuring a temperature of the battery pack 10a. For example, the resistance of the coding resistor is between 1 kOhm and 1 MOhm. The coding resistance is dependent on the values of energy store 70a. For example, the resistance of the NTC resistor is between 50 kOhm and 1 kOhm due to temperature. The NTC resistance is dependent on the values of energy store 70a.

The signal output unit 30a comprises at least one digital signal output element 36a. The digital signal output element 36a is provided for outputting the digital signal. The digital signal output element 36a is provided for receiving and/or transmitting the digital signal. The digital signal output element 36a at least partially forms a digital bus system 28a. Various protocols and driver circuits can be used for the digital bus system 28a, including but not limited to UART and LIN. The digital signal output element 36a comprises a transmission element 100a for transmitting the digital signal. The transmission element 100a forms a bus line 104a. The digital signal output element 36a comprises a receiver circuit 90a, in particular a receiver, for receiving and/or transmitting the digital signal. The digital signal output element 36a comprises a pull-down circuit 108a for receiving and/or transmitting the digital signal. The signal output unit 30a is connected to a ground 50a.

The digital signal output element 36a comprises an ESD protection circuit 96a. The ESD protection circuit 94a comprises at least one ESD suppressor diode (not shown). The ESD protection circuit 94a is configured so as to reduce existing capacity in the digital operating mode, preferably in conjunction with the analog signal output element 40a. The ESD protection circuit 94a is configured so as to reduce the capacity to a maximum of 100 nF, preferably to a maximum of 10 nF, advantageously to a maximum of 5 nF, and particularly preferably to a maximum of 1 nF. As a result, the switching edges of the bus line 104a can advantageously be transmitted immediately.

The bus line 104a is directly connected to the signal contact 34a. The analog signal and the digital signal are each transmissible via the bus line 104a. As a digital signal output element 38a, the electrical consumer 14a comprises the complimentary digital bus system 28a having at least one further transmission element 102a, in particular a bus line 106a, a receiver circuit 92a, a pull-down circuit 110a, and an ESD protection circuit 98a. The signal output unit 32a of the electrical consumer 14a is connected to a further ground 52a. The digital signal output element 36a of the battery pack 10a and the digital signal output element 38a form the digital bus system 28a.

The signal output unit 32a, in particular an electric circuit 44a of the signal output unit 32a, of the electrical consumer 14a comprises at least one series resistor 62a. The digital bus system 28a, in particular the signal output unit 32a of the electrical consumer 14a and the signal output unit 30a of the battery pack 10a, is connected via the additional series resistor 62a to the energy store 70a. The series resistor 62a has a resistance of in particular at least 100 Ohm, preferably at least 500 Ohm, advantageously 1 kOhm, and particularly preferably at least 2 kOhm. The energy store 70a is configured so as to provide a signal voltage of the signal output unit 30a for the digital operating mode.

The digital bus system 28a operates according to a master/slave principle. The master serves as the primary driver that provides a constant pull-up, e.g. 3.3 V or 5 V, wherein the master switches the digital bus system 28a to 0 V (pull-down) for transmitting the digital signal. The digital bus system 28a is provided at a data rate of at least 1 kBaud, preferably at least 10 kBaud, advantageously at least 50 kBaud, and particularly preferably at least 100 kBaud. Slower data rates can also be reasonable for specific applications.

The signal output unit 30a comprises at least one electric circuit 42a. The electric circuit 42a is configured so as to switch between a digital operating mode and an analog operating mode. The electric circuit 42a comprises at least circuit components of the battery pack 10a of the digital bus system 28a. The signal output unit 32a of the electrical consumer 14a comprises a further electric circuit 42a comprising the circuit components of the electrical consumer 14a of the digital bus system 28a. The signal output unit 30a in the analog operating mode is configured so as to output the analog signal. In the digital operating mode, the signal output unit 30a is configured so as to output the digital signal. The electric circuit 42a is configured so as to switch between the analog operating mode and the digital operating mode to at least one electric circuit component in such a way that the signal output unit 30a outputs only the analog signal or the digital signal, in particular via at least the same signal contact 34a of the connection interface 20a. The electric circuit 42a at least partially forms the digital bus system 28a. The electric circuit 42a is connected to the electric circuit 44a of the electrical consumer 14a.

In the analog operating mode, the electric circuit 42a is configured so as to provide a reading-out of the analog signal output element 40a, in particular the coding resistance or the NTC resistance. In the digital operating mode, the electric circuit 42a is configured so as to provide the transmission and/or reception of the digital signal, preferably during a communication of the control/regulation unit 24a of the battery pack 10a with the control/regulation unit 26a of the electrical consumer 14a.

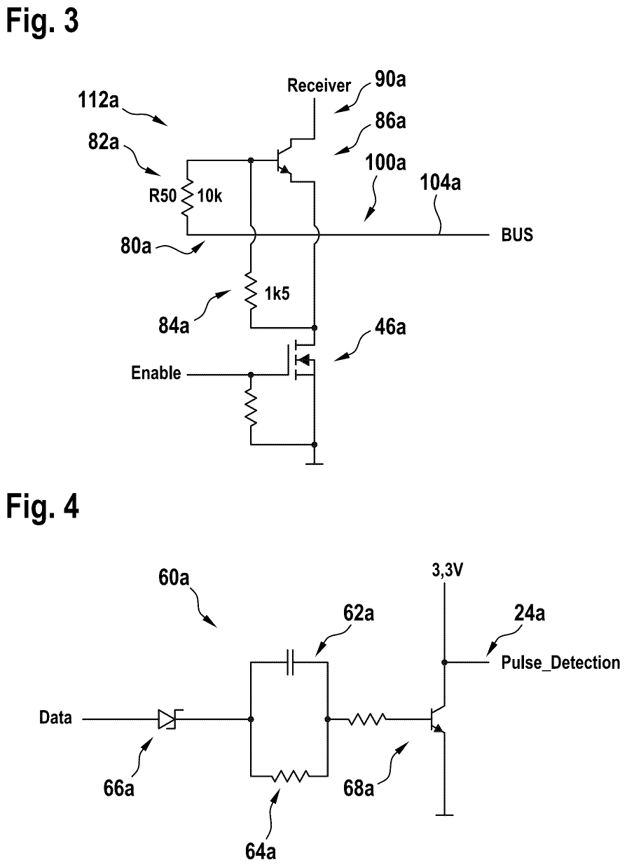

In the digital operating mode, the electric circuit 42a is configured so as to electrically disconnect the analog signal output element 40a of the signal output unit 30a from the signal contact 34a of the signal output unit 30a. The electric circuit 42a comprises at least one switching element 48a for electrically disconnecting the analog signal output element 40a. The switching element 48a is arranged directly on analog signal output element 40a. The switching element 48a is configured as a semiconductor switch, in particular as a MOSFET semiconductor switch. When using an NTC resistor as an analog signal output element 40a, the MOSFET semiconductor switch already established with an NTC resistor is configured as the switching element 48a. In the analog operating mode, the switching element 48a is closed. In the digital operating mode, the switching element 48a is open. In the analog operating mode of the signal output unit 30a, the electric circuit 42a is configured so as to electrically disconnect the digital signal output element 36a of the signal output unit 30a from the signal contact 34a (cf. FIG. 3).

FIG. 3 shows an input circuit 112a of the receiver circuit 90a of the signal output unit 30a of the battery pack 10a. The input circuit 112a is part of the electric circuit 42a of the signal output unit 30a.

The electric circuit 42a comprises at least one switching element 46a for electrically disconnecting the digital signal output element 36a. The switching element 46a for electrically disconnecting the digital signal output element 36a and the at least one further switching element 48a for disconnecting the analog signal output element 40a are configured separately from one another. The switching element 46a is configured so as to prevent the current flowing parallel to analog signal output element 40a in the analog operating mode. The switching element 46a is a semiconductor switch. The switching element 46a is an n-type MOSFET semiconductor switch. Alternatively, an NPN BJT can also be applied as a semiconductor switch. The first switching element 46a is arranged in the digital signal output element 36a, in particular in the digital bus system 28a, preferably in the input circuit 112a of the receiver circuit 90a of the digital signal output element 36a. In the analog operating mode of signal output unit 30a, the switching element 46a is configured so as to electrically disconnect leakage paths of the digital signal output element 36a with a ground 50a of battery pack 10a. In the analog operating mode, the switching element 46a is configured so as to prevent the current flowing parallel to analog signal output element 40a with the leakage paths after a ground 50a.

The signal output unit 30a comprises at least one voltage splitter 80a. The voltage splitter 80a is configured so as to compensate for a ground offset between the battery pack 10a and the electrical consumer 14a. The voltage splitter 80a is configured so as to compensate for a ground offset between the ground 50a of the battery pack 10a and the ground 52a of the electrical consumer 14a, in particular up to 2 V. In the input line 112a of the receiver circuit 90a, the voltage splitter 80a is arranged upstream of a semiconductor switch 86a. The voltage splitter 80a comprises an additional series resistor 82a and a leakage resistor 84a. By implementing an additional series resistance 82a of, for example, 10 kOhm and a leakage resistance 84a of 1.5 kOhm, a voltage splitter ratio of about 13% is achieved. This results in a “low” level influenced by ground offset being reduced from 2 V to about 260 mV. This value lies well below the switching threshold of semiconductor switch 86a. A “high” level still reaches a value of more than 1 V due to the signal voltage of the energy store 70a despite the voltage splitter 80a, which lies above the switching threshold of the semiconductor switch. Depending on the specific requirements of the system 12a, fine-tuning can be performed by varying the “high” level on the bus line 104, the switching thresholds of the semiconductor switch 86a, and the expected ground offsets. The semiconductor switch 86a is an NPN BJT semiconductor switch having a switching threshold of approximately 0.7 V.

FIG. 4 shows a circuit of an activation unit 60a of the signal output unit 30a of the battery pack 10a. The activation unit 60a is configured so as to switch from the analog operating mode to the digital operating mode upon detection and/or recognition of an activation signal. The activation signal is a digital signal. The activation unit 60a is configured so as to switch the at least one first switching element 46a and the at least one further switching element 48a upon detection of the activation signal.

The activation unit 60a is provided for a pulse detection on the bus line 104. The activation signal is a defined pulse sequence comprising signal flanks within a defined time period. The activation signal is binary, wherein any defined binary coding is conceivable, such as “101 0101” for example. The activation unit 60a is configured so as to at least substantially prevent interference signals of the digital signal output element 36a in the analog operating mode. The control/regulation unit 24a of the battery pack 10a or the control/regulation unit 26a of the electrical consumer 14a is provided for generating the activation signal.

The activation unit 60a comprises at least one high pass filter 62a. The high pass filter 62a is configured so as to permanently prohibit a current flow in the activation unit 60a, in particular in the analog operating mode. The activation unit 60a comprises at least one transistor 68a, in particular an NPN BJT transistor. The high pass filter 62a is provided in order to direct the pulse sequence, preferably the activation signal, filtered to the transistor 62a. The transistor 62a is provided in order to transmit the pulse sequence, preferably the activation signal, to the control/regulation unit 24a. The control/regulation unit 24a is provided in order to check the pulse sequence, preferably of the activation signal. The control/regulation unit 24a is provided in order to set the digital operating mode as the activation signal when verifying the pulse sequence, wherein in particular the control/regulation unit 24a closes the first switching element 46a for electrically disconnecting the digital signal output element 36a and opens the further switching element 48a for electrically disconnecting the analog signal output element 40a.

The activation unit 60a comprises at least one diode 66a, which is configured so as to decouple a capacitance of the high pass filter 62a from the transmission element 100a, in particular the bus line 102a. The diode 66a is configured as a Schottky diode due to a lower flux voltage. The activation unit 60a has a resistor 64a connected in parallel to a high-pass capacitor. The resistor 64a is provided to ensure a defined discharge of the capacitor. For example, the resistor 64a has a value of 1 MOhm.

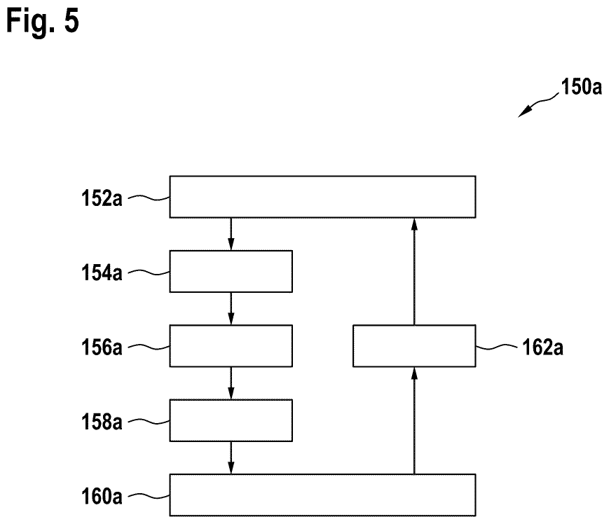

FIG. 5 shows a method 150a for operating the battery pack 10a. In at least one method step, there is a switch between the analog operating mode and the digital operating mode.

In a method step 152a, the signal output unit 30a is operated in the analog operating mode. With the signal output unit 30a, the analog signal is output via signal contact 34a.

In a further method step 154a for initiating a change to the digital operating mode, the activation signal is generated with the control/regulation unit 24a of the battery pack 10a or the control/regulation unit 26a of the electrical consumer 14a. The activation signal is transmitted on the bus line 104a.

In a further method step 156a, the activation unit 60a is detected. If a positive pulse arises on the bus line 104a, it is filtered with the high pass filter 62a and passed on to the base of the transistor 68a. The transistor 68a is temporarily switched on and passes the pulse sequence on to the control/regulation unit 24a.

In a further method step 158a, after detection of the activation signal with the activation unit 60a, there is a switch from the analog operating mode to the digital operating mode. If the activation signal is detected with the control/regulation unit 24a from the pulse sequence, the first switching element 46a and the at least one further switching element 48a are switched over with the control/regulation unit 24a. When switching from the analog operating mode to the digital operating mode, at least the first switching element 46a is closed for the electrical disconnection of the digital signal output element 36a and the at least one further switching element 48a is opened for the electrical disconnection of the analog signal output element 40a.

In a further method step 160a, the signal output unit 30a operates in the digital operating mode. The signal output unit 30a is provided for outputting the digital signal via the signal contact 34a.

If a digital signal is not output or received via the signal output unit 30a, then there is a switch from the digital operating mode to the analog operating mode. In a further method step 162a, at least the first switching element 46a is opened for the electrical disconnection of the digital signal output element 36a, and in particular the at least one further switching element 48a is closed for the electrical disconnection of the analog signal output element 40a. The leakage paths of the digital signal output element 36a are opened after a ground 50a.

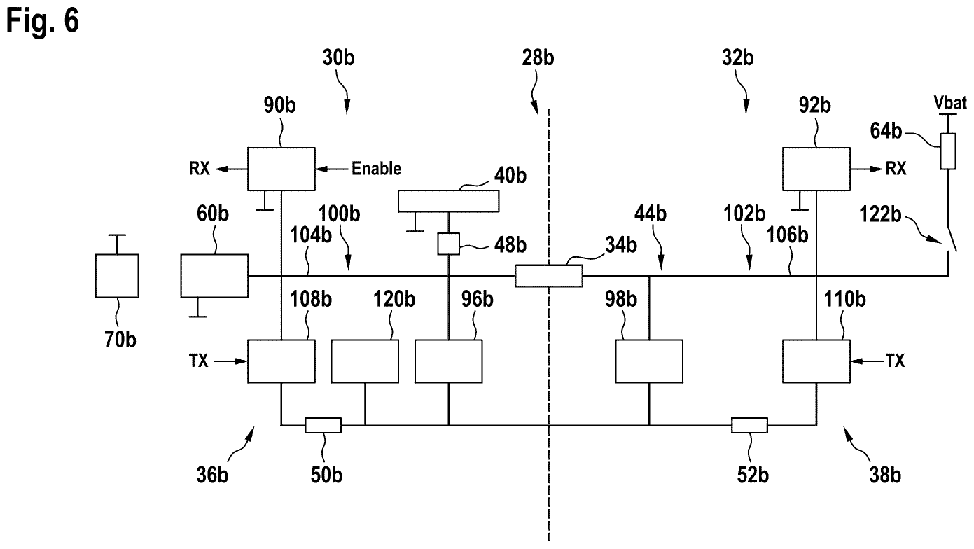

FIG. 6 shows a further exemplary embodiment of the disclosure. The following descriptions and the drawings are substantially limited to the differences between the exemplary embodiments, wherein reference can also be made in principle to the drawings and/or the description of the other exemplary embodiments, in particular FIGS. 1 to 5, with regard to identically described components, in particular with regard to components having the same reference numerals. To differentiate between the exemplary embodiments, the letter a is placed after the reference numerals of the exemplary embodiment in FIGS. 1 to 5. In the exemplary embodiment in FIG. 6, the letter a is replaced by the letter b.

FIG. 6 conceptually shows an alternative design of a signal output unit 30b of a battery pack 10b according to the disclosure. The signal output unit 30b is provided for outputting a digital signal or an analog signal via a signal contact 34b to an electrical consumer 14b, in particular a signal output unit 32b of the electrical consumer 14b.

The signal output unit 30b comprises at least one voltage regulation unit 120b. The voltage regulation unit 120b is configured so as to stabilize and/or regulate a signal voltage. The voltage regulation unit 120b is configured so as to down-regulate the signal voltage to a constant value, which is substantially smaller than an output voltage of an energy store 70b of the battery pack 10b.

The voltage regulation unit 120b comprises at least one diode, in particular a Zener diode, for example a Zener diode type 8 V (not shown). The voltage regulation unit 120b comprises an additional series resistor (not shown). A series resistor having 330 Ohm is particularly suitable. The voltage regulation unit 120b down-regulates the output voltage by at least 10%, preferably by at least 25%, advantageously by at least 33%, and particularly preferably by at least 45%. The voltage regulation unit 120b constantly controls the signal voltage to 8 V. A receiver circuit 90b of the signal output unit 30b is configured so as to translate the signal voltage into a variable that is processable by a control/regulation unit 24b of the battery pack 10b, in particular a “logic 1,” for example by a translation to 3.3 V. The receiver circuit 90b comprises a semiconductor switch 86b for the translation.

The signal output unit 32b of the electrical consumer 14b comprises a switch 122b. The switch 122b is configured so as to disconnect an energy store 70b of the battery pack 10b from at least the signal output unit 32b of the electrical consumer 14b and the signal output unit 30b of the battery pack 10b.

What is claimed is:

1. A battery pack, comprising:
at least one connection interface configured to be connected to an electrical consumer and/or to a charging device; and
a signal output unit configured so as to output at least one analog signal and at least one digital signal via at least one shared signal contact of the connection interface,
wherein the signal output unit comprises at least one electric circuit which is configured so as to switch between a digital operating mode of the signal output unit and an analog operating mode of the signal output unit.

2. The battery pack according to claim 1, wherein the at least one electric circuit is configured so as to electrically disconnect an analog signal output element of the signal output unit from the signal contact in the digital operating mode of the signal output unit.

3. The battery pack according to claim 2, wherein the at least one electric circuit is configured so as to electrically disconnect a digital signal output element of the signal output unit from the signal contact in the analog operating mode of the signal output unit.

4. The battery pack according to claim 3, wherein the at least one electric circuit comprises:
at least a first switching element configured to electrically disconnect the digital signal output element, and
at least one further switching element configured to electrically disconnect the analog signal output element.

5. The battery pack according to claim 4, wherein the first switching element is configured so as to electrically disconnect leakage paths of the digital signal output element with a ground of the battery pack in the analog operating mode of the signal output unit.

6. The battery pack according to claim 1, wherein the signal output unit comprises at least one activation unit configured so as to switch from the analog operating mode to the digital operating mode in case of a detection and/or recognition of a digital activation signal.

7. The battery pack according to claim 1, further comprising at least one energy store configured so as to provide at least one utility energy for an operation of the electrical consumer and a signal voltage of the signal output unit for the digital operating mode.

8. The battery pack according to claim 7, wherein the signal output unit comprises at least one voltage regulation unit which is configured so as to stabilize and/or regulate the signal voltage in order to down-regulate it to a constant value, which is smaller than an output voltage of the energy store.

9. The battery pack according to claim 1, wherein the signal output unit comprises at least one voltage splitter configured so as to compensate for a ground offset between the battery pack and the electrical consumer and/or the charging device.

10. A system having a battery pack according to claim 1 and having an electrical consumer and/or having a charging device, each comprising at least one connection interface for connecting with the battery pack and at least one signal output unit which is configured at least so as to output an analog signal via the connection interface at least via the signal contact of the battery pack.

11. A method for operating a battery pack according to claim 1, wherein, in at least one method step, there is a switch between an analog operating mode and a digital operating mode.

12. The battery pack according to claim 1, wherein the electrical consumer is an electric hand tool.

13. The battery pack according to claim 6, wherein the least one activation unit is further configured to switch the at least one first switching element and the at least one further switching element.

14. The battery pack according to claim 1, wherein the at least one electric circuit is configured so as to electrically disconnect a digital signal output element of the signal output unit from the signal contact in the analog operating mode of the signal output unit.
